(19) United States
(12) Patent Application Publication
(10) Pub. No.: US 2026/0116723 A1
(43) Pub. Date: Apr. 30, 2026

(54) LOAD JAM DETECTOR

(71) Applicant: Teradyne, Inc., North Reading, MA (US)

(72) Inventor: Geoffrey B. Keating, Boston, MA (US)

(73) Assignee: Teradyne, Inc., North Reading, MA (US)

(21) Appl. No.: 18/932,516

(22) Filed: Oct. 30, 2024

(51) Int. Cl. B66F 9/24; B25J 5/00; B25J 9/16; B25J 13/08; B25J 19/02; B66F 9/06

(52) U.S. Cl. CPC B66F 9/24; B25J 5/007; B25J 9/1653; B25J 9/1669; B25J 13/088; B25J 19/023; B66F 9/063

(57) ABSTRACT

A mobile autonomous robot can include a pallet fork for lifting and carrying pallets. During pallet load operations, pallets may become jammed in the fork, which may be referred to as a load jam. To detect load jams, the mobile robots described herein may determine the velocity of a pallet relative to the mobile robot. When the velocity difference falls within a threshold amount, the mobile robot may determine that a load jam has occurred, and may cease or modify the pallet load operation. By autonomously detecting load jams, the mobile robot may increase safety and performance.

### BACKGROUND

### Field

The present technology relates to mobile robots having pallet forks and to methods and apparatus for determining and whether a pallet load operation has a jam.

### Related Art

Mobile robots can move autonomously or through guidance to complete one or more actions. High payload mobile robots can carry a load and move the load from one location to another.

### BRIEF SUMMARY

According to aspects of the disclosure, there is provided a mobile robot, comprising: a set of wheels configured to move the mobile robot; a pallet fork configured to lift and carry pallets; a plurality of sensors comprising: at least one camera configured to output image data; and at least one second sensor configured to provide kinematic data; and at least one processor configured to: determine that a pallet load operation has initiated; identify a pallet surface; and determine a velocity of the pallet surface relative to the mobile robot during the pallet load operation using image data output from the at least one camera and kinematic data provided by the at least one second sensor.

In some embodiments, determining the velocity of the pallet surface relative to the mobile robot comprises determining whether a velocity of the pallet surface is within a threshold value of a velocity of the mobile robot.

In some embodiments, the at least one processor is further configured to: in response to determining that the velocity of the pallet surface is within the threshold value of the velocity of the mobile robot, trigger an alarm condition; and based on the alarm condition, cease the pallet load operation.

In some embodiments, determining the velocity of the pallet surface relative to the mobile robot comprises using an intensity camera to: select at least one point on the pallet surface; determine a position of the at least one point on the pallet surface in image data from at least two frames in time; and determine the velocity of the pallet surface relative to the mobile robot based on a difference in the position of the at least one point on the pallet surface in the image data from the at least two frames in time.

In some embodiments, the at least one camera comprises a depth camera; the at least one second sensor comprises an odometry encoder; and determining the velocity of the pallet surface relative to the mobile robot comprises determining the velocity of the pallet surface relative to the mobile robot using the depth camera and the odometry encoder.

In some embodiments, the at least one camera comprises an intensity camera; and identifying the pallet surface comprises identifying the pallet surface using the intensity camera.

In some embodiments, the plurality of sensors comprises a depth camera and an intensity camera; and determining the velocity of the pallet surface relative to the mobile robot comprises fusing kinematic data provided by (i) the depth camera and (ii) the intensity camera.

In some embodiments, the at least one camera comprises a depth camera and an intensity camera; the at least one second sensor comprises at least one of an ultrasonic sensor or a LiDAR sensor; and determining the velocity of the pallet surface relative to the mobile robot comprises fusing kinematic data provided by (i) the depth camera, (ii) the intensity camera, and (iii) the at least one of the ultrasonic sensor or the LiDAR sensor.

According to aspects of the disclosure, there is provided a method of detecting load jams during pallet load operations of a mobile robot, the method comprising: determining that a pallet load operation has initiated; identifying a pallet surface; and determining a velocity of the pallet surface relative to the mobile robot during the pallet load operation using image data output from at least one camera and kinematic data provided by at least one second sensor.

In some embodiments, the method further comprises: detecting a pallet; positioning the mobile robot facing the pallet; and performing the pallet load operation.

In some embodiments, determining the velocity of the pallet surface relative to the mobile robot comprises determining whether a velocity of the pallet surface is within a threshold value of a velocity of the mobile robot.

In some embodiments, the method further comprises: in response to determining that the velocity of the pallet surface is within the threshold value of the velocity of the mobile robot, triggering an alarm condition; and based on the alarm condition, ceasing the pallet load operation.

In some embodiments, determining the velocity of the pallet surface relative to the mobile robot comprises using an intensity camera to: select at least one point on the pallet surface; determine a position of the at least one point on the pallet surface in image data from at least two frames in time; and determine the velocity of the pallet surface relative to the mobile robot based on a difference in the position of the at least one point on the pallet surface in the image data from the at least two frames in time.

In some embodiments, determining the velocity of the pallet surface relative to the mobile robot comprises determining the velocity of the pallet surface relative to the mobile robot using a depth camera and an odometry encoder.

In some embodiments, identifying the pallet surface comprises identifying the pallet surface using an intensity camera.

In some embodiments, determining the velocity of the pallet surface relative to the mobile robot comprises fusing kinematic data provided by (i) a depth camera and (ii) an intensity camera.

In some embodiments, determining the velocity of the pallet surface relative to the mobile robot comprises fusing kinematic data provided by (i) a depth camera, (ii) an intensity camera, and (iii) at least one of an ultrasonic sensor or a LiDAR sensor.

According to aspects of the disclosure, there is provided a at least one non-transitory computer-readable storage medium having instructions encoded thereon that, when executed by at least one processor, cause the at least one processor to perform a method of detecting load jams during pallet load operations of a mobile robot, the method comprising: determining that a pallet load operation has initiated; identifying a pallet surface; and determining a velocity of the pallet surface relative to the mobile robot during the pallet load operation using image data output from at least one camera and kinematic date provided by at least one second sensor.

In some embodiments, identifying the pallet surface comprises identifying the pallet surface using an intensity camera; and determining the velocity of the pallet surface relative to the mobile robot comprises: using the intensity camera to: select at least one point on the pallet surface; determine a position of the at least one point on the pallet surface in image data from at least two frames in time; and determine velocity data based on a difference in the position of the at least one point on the pallet surface in the image data from the at least two frames in time; determining the velocity of the pallet surface relative to the mobile robot by fusing the velocity data and depth data from the at least one second sensor.

In some embodiments, determining the velocity of the pallet surface relative to the mobile robot comprises fusing kinematic data provided by (i) a depth camera and (ii) an intensity camera.

In some embodiments, fusing the velocity data and depth data from the at least one second sensor comprises: inputting, into a model, the velocity data and the depth data from the at least one second sensor; and determining, based on an output from the model, the velocity of the pallet surface relative to the mobile robot.

In some embodiments, determining the position of the at least one point on the pallet surface in the image data from the at least two frames in time comprises: inputting, into a trained statistical model image data from the at least two frames in time; and determining, based on an output from the trained statistical model, the position of the at least one point on the pallet surface in the image data from the at least two frames in time.

### BRIEF DESCRIPTION OF DRAWINGS

Various aspects and embodiments will be described with reference to the following exemplary and non-limiting figures. It should be appreciated that the figures are not necessarily drawn to scale. Items appearing in multiple figures are indicated by the same or a similar reference number in all the figures in which they appear.

FIG. 1 is a perspective view of a mobile robot, according to some embodiments;

FIG. 2 is a top view of a mobile robot in an operating environment, according to some embodiments;

FIG. 3 is a flow diagram of a pallet load operation of a mobile robot, according to some embodiments;

FIG. 4 is a flow diagram of a pallet load jam operation of a mobile robot, according to some embodiments;

FIG. 5 is a flow diagram of a pallet detection operation of a mobile robot, according to some embodiments;

FIG. 6 is a flow diagram of another pallet load jam operation of a mobile robot, according to some embodiments;

FIG. 7 shows sensor images and data of a mobile robot during a pallet load operation, according to some embodiments;

FIGS. 8A-8B are a block diagram of components of a mobile robot, according to some embodiments;

FIG. 9 is a flow diagram of an optical flow operation of a mobile robot, according to some embodiments;

FIG. 10 is a plot of data for determining a load jam of a mobile robot, according to some embodiments;

FIG. 11 shows a process flow for a method of detecting load jams during pallet load operations of a mobile robot; and

FIG. 12 is an example block diagram of a special purpose computer system that can be configured to execute the functions discussed herein.

### DETAILED DESCRIPTION

A mobile autonomous robot can include a pallet fork for lifting and carrying pallets. During pallet load operations, pallets may become jammed in the fork, which may be referred to as a load jam. To detect load jams, the mobile robots described herein may determine the velocity of a pallet relative to the mobile robot. When the velocity difference falls within a threshold amount, the mobile robot may determine that a load jam has occurred, and may cease or modify the pallet load operation. By autonomously detecting load jams, the mobile robot may increase safety and performance.

To detect load jams, the mobile robot may include a plurality of sensors that detect information about the mobile robot, its surroundings, and pallets. Collecting data from the different sensors may allow the robot to fuse the data to quickly and accurately detect load jams. In some embodiments, the plurality of sensors includes at least one camera that outputs image data and at least one second sensor, such as an inertial motion unit (IMU) that provides kinematic data. Using at least one processor, the mobile robot may detect when pallet load operations initiate (such as load or unload operations), and may identify a surface on the pallet, such as the front surface. The mobile robot may determine a velocity of the pallet surface relative to the mobile robot during the pallet load operation using image data output from the at least one camera and kinematic data provided by the at least one second sensor, and may use to velocity of the pallet surface to determine if a load jam occurs.

Mobile robots may be used in various applications. For example, high payload mobile robots such as tuggers, forklifts, stackers, and jacks may transport boxes, palettes, or other objects in a warehouse, fulfillment center, or other facility. As an example, a high payload mobile robot may include a fork having prongs that can be positioned to slide below a palette and lift it up for transport such that the mobile robot serves the function of a conventional forklift but is driverless.

Mobile robots can include a pallet fork for moving palletized loads in warehouse or other environments. A pallet moving operation performed by such a mobile robot includes pallet loading operations to load and unload the palletized load onto and off of the pallet fork. Mobile robots may include a controller that determines the pose of a pallet in order to guide the mobile robot to the proper position to pick up the pallet. Sometimes, during a pallet loading operation, a palletized load may jam. A pallet load jam may cause the palletized load to fail to completely load or unload, which may result in the palletized load having undesired motion. For example, when the pose determination performed by the mobile robot produces an inaccurate or erroneous result, the robot could push the pallet, causing damage, threatening the safety of humans working alongside the robot, and/or reducing the productivity of the mobile robot.

According to various embodiments described herein, mobile robot systems and methods may be used to detect jams of palletized loads and modify operation of the robot in response to such detection, thus improving safety and robot performance. Accordingly, the systems and method described herein audit the performance of pallet pose estimation processes, and provide an additional layer of safety reliability to pallet load operations, mitigate damages from broken pallets, poor pose estimation, or other unexpected circumstances that cause a robot to push a pallet.

According to some embodiments, a load jam system of a mobile robot may perform sensor fusion to estimate the velocity of a target pallet. In various embodiments, different combination of sensors may be used for this velocity estimation. For example, the mobile robot may use sensors including robot odometry sensors such as an IMU, depth cameras, intensity (e.g., greyscale or color) cameras, LiDAR, ultrasonic sensors, and other sensors capable of providing depth information. The mobile robot may receive streams of information from these sensors, and preprocess the information before fusing the information using a filter such as a Kalman filter. The fused information may then be used to estimate the distance from the fork of the mobile robot to a surface of the pallet, the velocity of the robot, and the velocity of the pallet.

Load jams may have different causes. For example, during a pick operation, where a pallet is loaded onto the robot, one cause may be the mobile robot pushing pallet face, for example, because the pallet fork has not been inserted. This produces a biased transverse pallet pose, which may be recoverable, but also has the risk of pushing the pallet again and in the same direction. Second, the mobile robot may push debris, or the pallet board may be broken. This jam occurs when an object has wedged between the forks and the pallet pillars, or the pallet is defective and is generally unrecoverable. Additionally, during a place operation, where a pallet is unloaded off of the robot, one cause may again be from debris or broken pallet, where, similar as the pick example, something has stuck on the forks a degree that the pallet will not slide off the forks. This generally occurs early in the place process if a board gets stuck in the fork bogey slot and is generally unrecoverable. Second, the mobile robot's navigation system may turn too early, hitting the pallet stringers on exit, which is also generally unrecoverable.

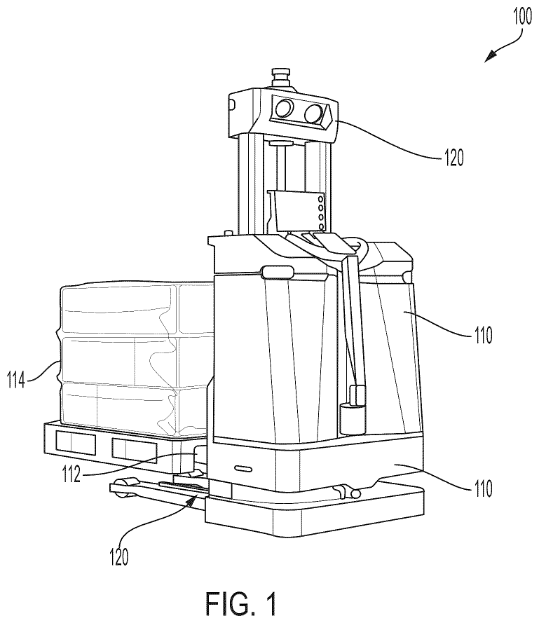

FIG. 1 is a perspective view of a mobile robot 100 according to one or more embodiments. The exemplary mobile robot 100 shown in FIG. 1 is a high payload autonomous mobile robot (AMR) that may autonomously pick up and carry a load. For example, the mobile robot 100 may be a high payload pallet jack in some embodiments. The mobile robot 100 has a body 110 that may contain a controller for controlling autonomous operation of the mobile robot. The controller may comprise at least one processor and at least one non-transitory computer-readable storage medium having instructions encoded thereon that, when executed by at least one processor, cause the at least one processor to perform various steps, described in more detail below. The mobile robot 100 may be configured to propel itself using a set of wheels another propulsion device. The mobile robot 100 includes one or more forks 112 for engaging with a load 114 (e.g., a palletized load comprising a load on a pallet) to be carried. Furthermore, the mobile robot 100 includes a set of sensors 120, which may be used for navigation and detecting pallets, described in more detail below. The sensors 120 may be disposed in various locations on the mobile robot 100, as illustrated in FIG. 1. For example, sensors 120 may be disposed between the fork 112, at the top of the mobile robot 100, around the perimeter of the mobile robot 100, or in other suitable locations that provide a view of the load 114 and the surroundings of the mobile robot 100.

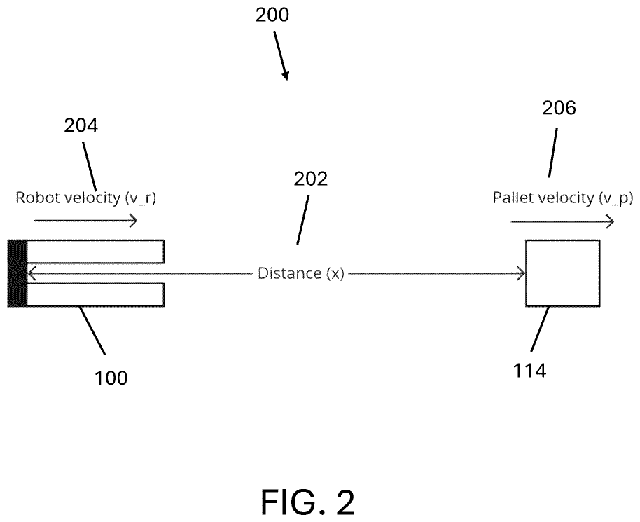

FIG. 2 shows the mobile robot 100 in an operating environment 200. As illustrated in FIG. 2 the mobile robot is spaced a distance 202 from the load 114, which may be a pallet. During a pallet load operation, the mobile robot 100 may determine the distance 202 and also determine the robot velocity 204 and the pallet velocity 206. Based on the robot velocity 204 and the pallet velocity 206 the mobile robot may determine a relative velocity between the mobile robot and the pallet period using the relative velocity into the distance the mobile robot may determine when a load jam occurs as described herein period

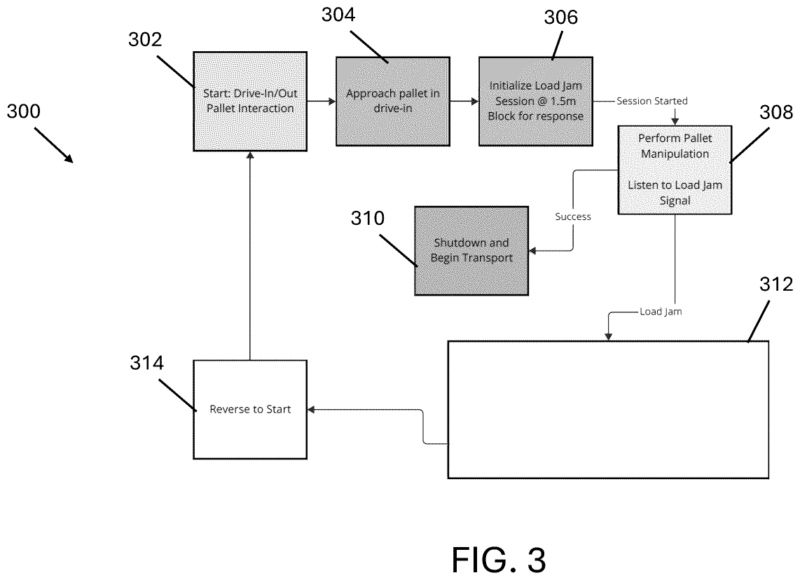

FIG. 3 is a flow diagram of a pallet load operation 300 of a mobile robot, according to some embodiments. At operation 302, the mobile robot starts by driving in or out of a pallet interaction. At operation 304, the mobile robot approaches a pallet for drive in. At operation 306, the mobile robot initializes a load jam operation at a target distance. In some embodiments the target distance may be 1.5 meters, 1.0 meters, 0.5 meters or less. When the load jam operation has started, at operation 308, the mobile robot performs pallet manipulation, such as by picking or placing the pallet. During operation 308, the mobile robot also detects whether a load jam has occurred. When the pallet manipulation is successful, such as because there is no load jam, at operation 310, the mobile robot may shutdown the pallet load operation and begin transporting the pallet to its destination. When a load jam is detected, at operation 312, the mobile robot may perform a load jam operation. At operation 314, the mobile robot may reverse to start, after which the pallet load jam 300 may be reinitiated at operation 302.

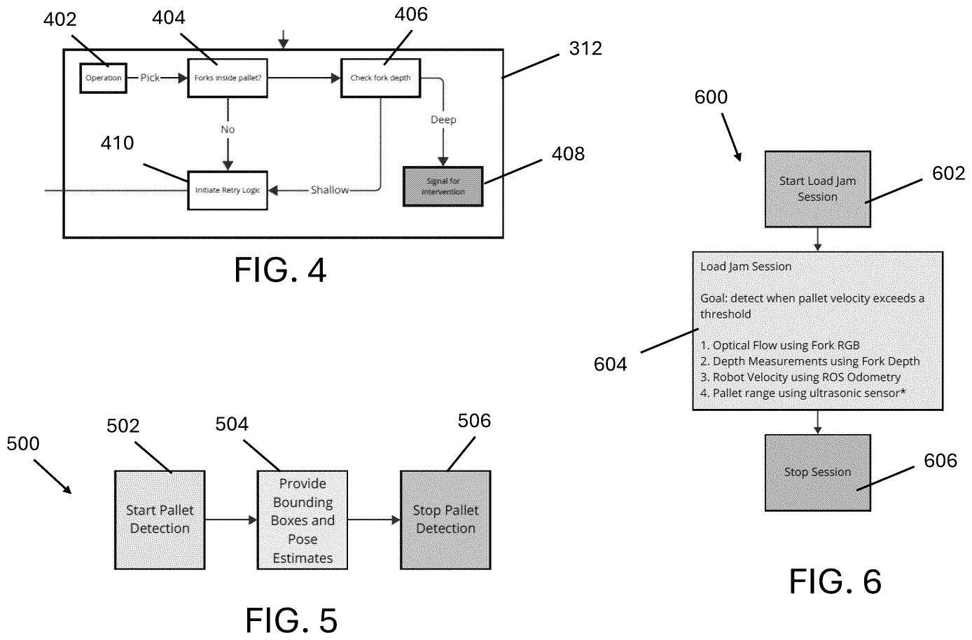

FIG. 4 is a flow diagram of a pallet load jam operation 312 of a mobile robot, according to some embodiments. The load jam operation 312 may be performed when a load jam is detected. At operation 402, the mobile robot determines what operation is being performed. At operation 404, the mobile robot determines whether the pallet fork is disposed inside the pallet. Operation 404 and proceeding operations may be performed for a pick operation, and may also be performed for place operations. At operation 406, the mobile robot determines fork depth within the pallet. When the depth is deep, such as above a threshold depth, at operation 408, the mobile robot triggers a signal for intervention, such as intervention from another robot or from a human operator. When the depth is shallow, such as below a threshold depth, or when the forks are not disposed inside the pallet, at operation 410, the mobile robot initiates a retry of the load operation, and may proceed to operation 314 as described above.

FIG. 5 is a flow diagram of a pallet detection operation 500 of a mobile robot, according to some embodiments. At operation 502, the mobile robot starts the pallet detection operation. At step 504, the mobile robot determines bounding boxes for a pallet face, and provides pose estimates for the pallet and/or the mobile robot. The bounding boxes for a pallet face may be determined with one or more of the cameras described herein, and/or with one or more of the depth sensors described herein. At operation 506, the mobile robot stops the pallet detection operation.

FIG. 6 is a flow diagram of another pallet load jam operation 600 of a mobile robot, according to some embodiments. Pallet load jam operation 600 may be performed during the pallet manipulation of operation 308, while the mobile robot is detecting whether a load jam has occurred. At operation 602, the mobile robot initiates a load jam session, which may be in response to a pallet load operation occurring. At operation 604, the mobile robot performs a load jam session to determine whether pallet velocity exceeds a threshold. As is described in more detail below, the load jam session performs optical flow using an RGB or other image sensor, collects depth measurements using a depth sensor, determines mobile robot velocity using an odometry sensor, and/or determines pallet range using an ultrasonic sensor. The mobile robot then fuses the data from these sensors and determines whether the pallet velocity exceeds the threshold. If the pallet velocity exceeds the threshold, a load jam is detected. If the pallet velocity does not exceed the threshold, the load jam session continues while the pallet load operation is in process. At operation 606, the mobile robot stops the load jam session, which may in response to the pallet load operation ending.

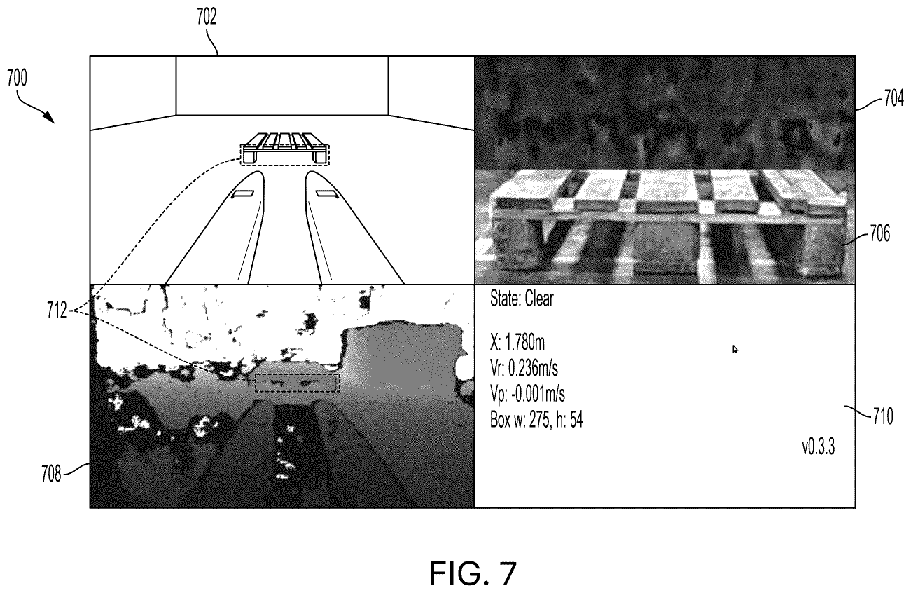

FIG. 7 shows sensor images and data of a mobile robot during a pallet load operation, according to some embodiments. The sensor and image data forms data set 700. Data set 700 may include, among other data, intensity camera image data 702 from an intensity camera, such as an RGB or greyscale camera. The data set 700 may also include optical flow data 704, which may be determined from the intensity camera image data 706 in an optical flow operation described in more detail below. The intensity camera image data 706 may be cropped from the intensity camera image data 702 to a region of interest that includes the pallet face. The data set 700 may also include depth camera image data 708 from a depth camera. As shown in the intensity camera image data 702 and the depth camera image data 708, the mobile robot may identify a pallet surface 712. For example, the pallet surface may be a loading face of the pallet closest to the mobile robot. The data set 700 may also include parameters determined by the mobile robot using the data in the data set. For example, FIG. 7 illustrates exemplary parameters 710. In FIG. 710 the parameters 710 include a load jam state (“clear” in the example), a distance between the mobile robot and the pallet surface (“X: 1.780 m” in the example), a velocity of the mobile robot (“Vr: 0.236 m/s” in the example), a velocity of the pallet (“Vp: −0.001 m/s” in the example) and pallet surface dimensions (“Box w: 275, h: 54” in the example). These parameters may be determined according to the operations described in more detail below.

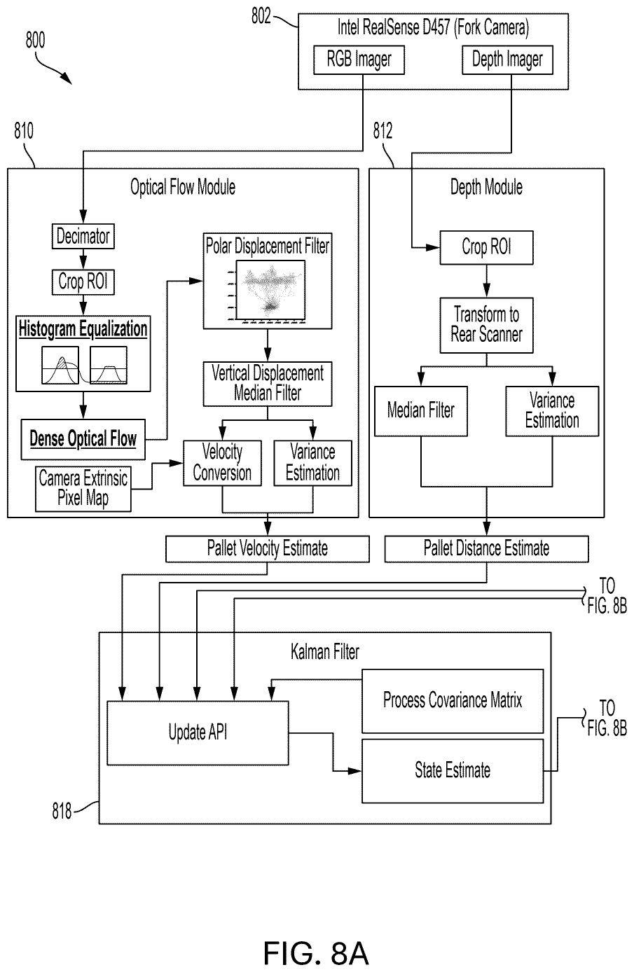

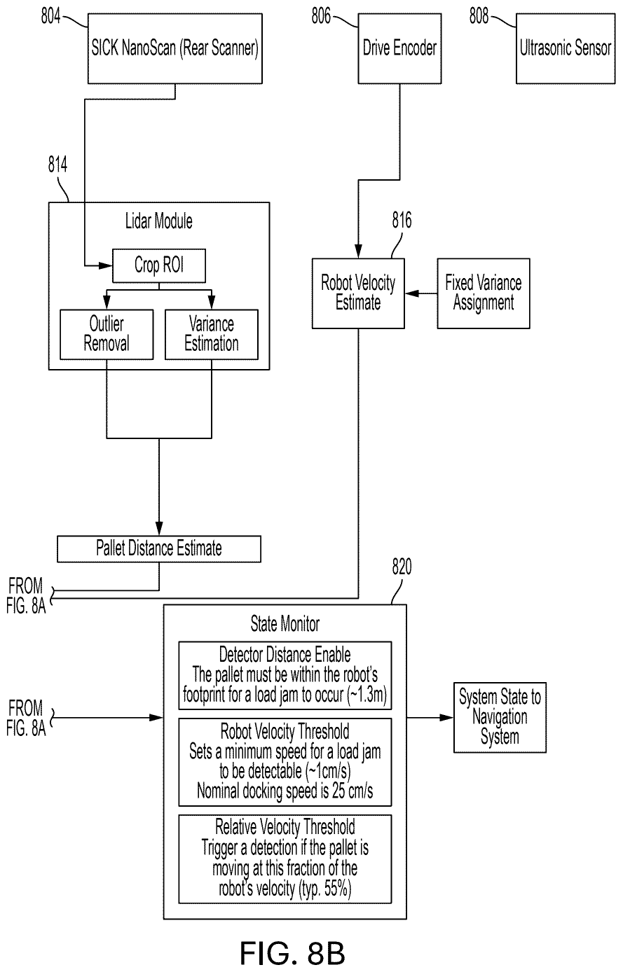

FIGS. 8A-8B are a block diagram of components 800 of a mobile robot, according to some embodiments. As shown in FIGS. 8A-8B, a mobile robot such as the mobile robot 100 may include a set of sensors 120 that includes one or more image sensors 802 (which may include (1) a intensity camara such as an RGB or greyscale camera, and (2) a depth camera), a LiDAR sensor 804, a odometry encoder 806 such as an IMU or drive encoder for the mobile robot, and an ultrasonic sensor 808. The mobile robot may further include various preprocessing modules, such as an optical flow module 810, a depth module 812, a LiDAR module 814, and an odometry module 816. The preprocessing modules may provide inputs to a filter 818, which may be a Kalman filter. The Kalman filter may provide an output indicating a system state to a state monitor 820. In various embodiments, the state monitor 820 is configured to analyze the system state to determine when a load jam occurs. If a load jam occurs, the state monitor 820 may provide an alert to a navigation system indicating that the system is in a state of load jam. The navigation system may then take corrective action or cease motion of the mobile robot, and may request intervention from a human operator.

The optical flow module 810 provides an estimate of pallet velocity using intensity camera image data. The optical flow module 810 receives intensity camera image data from the one or more image sensors 802. The optical flow module 810 may then decimate the intensity camera image data to reduce the number of image frames. Next, the optical flow module 810 may crop the intensity camera image data to a region of interest, such as a region of interest that include an identified pallet surface. The optical flow module 810 may then apply histogram equalization and dense optical flow to the intensity camera image data. The optical flow module 810 may then apply one or more filters to the intensity camera image data, such as a polar displacement filter and a vertical displacement median filter. Using a camera extrinsic pixel map, the optical flow module 810 may perform velocity conversion, and the optical flow module 810 may also perform variance estimation. Thereafter, the optical flow module 810 may output a pallet velocity estimate.

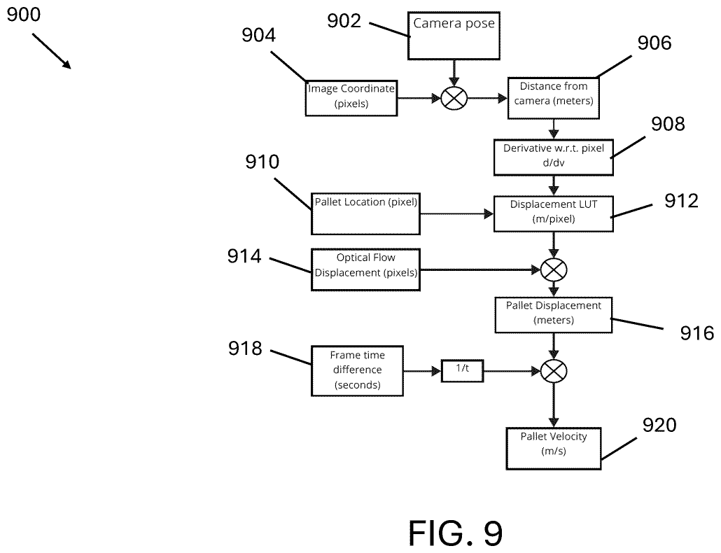

FIG. 9 is a flow diagram of an optical flow operation 900 of a mobile robot, according to some embodiments. The optical flow module 820 may determine the velocity of the pallet surface relative to the mobile robot by selecting one or more points on the pallet surface and determining a position of the one or more points on the pallet surface in image data from at least two frames in time, and then determining the velocity based on a difference in the position of the one or more points in the image data from the at least two frames in time.

At operation 902, the optical flow module 810 determines pose of the intensity camera. At operation 904, the optical flow module 810 determines image coordinates (e.g., pixels) in intensity camera image data. At operation 906, the optical flow module 810 determines distances from the camera for different image coordinates or pixels (e.g., in meters) using the camera pose and the image coordinates. Given a camera pose, each pixel in an image maps to a distance in the floor plane, where the robot is disposed on the floor plane. This map depends on the camera pitch (e.g., how high the camera is pointing, exposing expose more or less fork in the image) and camera height above the forks. Camera pose may be statically determined during a calibration process. In operation 908, the optical flow module 810 determines a derivative with respect to the pixels that represents change amount of distance from the camera, per pixel. In operation 910, the optical flow module 810 determines a pixel corresponding to the location of the pallet, such as one or more pixels on the pallet face. The pixels on the pallet face may be selected in any suitable manner, such as by identifying the pallet face and then selecting one or more pixels within the boundary of the pallet face. In some embodiments, the points may be selected using a model, such as a trained statistical model. The intensity camera image data may be input to the model, and the model may provide, as output, the selected points on the pallet face.

In operation 912, the optical flow module 810 uses the derivative and the pallet location with a look up table to determine displacement relative to pixels (e.g., meters per pixel). In operation 914, the optical flow module 810 determines optical flow displacement in the intensity camera image data in pixels. The optical flow displacement may represent a number of pixels that the selected point on the pallet face has moved in a time frame. In operation 916, the optical flow module 810 uses the displacement in meters per pixel and the optical flow displacement in pixels to determine pallet displacement in meters. In operation 918, the optical flow module 810 determines a difference between two frames of time for two or more pieces of intensity camera image data. In operation 920, the optical flow module 810 uses the frame time difference (e.g., in seconds) and the pallet displacement (e.g., in meters) to determine the pallet velocity (e.g., in meters per second).

Returning to FIGS. 8A-8B, the depth module 812 also provides an estimate of pallet distance using depth camera image data. The redundancy of depth information may provide more accurate state information output from the filter 818, and may also allow for quicker load jam detection times. The depth module 812 receives depth camera image data from the one or more image sensors 802. The depth module 812 may crop the depth camera image data to a region of interest, such as a region of interest that include an identified pallet surface. The depth module may then perform a transform using data from a different sensor, such as a LiDAR scanner. The depth module 812 may then apply a median filter and perform variance estimate. Thereafter, the depth model 812 may output a pallet distance estimate.

The LiDAR module 814 provide a pallet distance estimate using LiDAR data. The LiDAR module 814 receives LiDAR data from the LiDAR sensor 804. The LiDAR 814 may crop the LiDAR data to a region of interest, such as a region of interest that include an identified pallet surface. The LiDAR module 814 may then perform outlier removal and variance estimation on the LiDAR data. Thereafter, the LiDAR model 814 may output a pallet distance estimate.

The odometry module 816 provides an estimate of robot velocity using odometry sensor data. The odometry module 816 receives odometry information from the odometry encoder 806. The odometry module may provide fixed variance assignment, and may output a mobile robot velocity estimate.

The mobile robot may include other sensor and module arrangements. For example, in some embodiments, the ultrasonic sensor 808 may be used to perform pallet velocity estimation, pallet distance estimation, and/or robot velocity estimation. In various embodiments, the mobile robot may use any appropriate sensors for determine pallet velocity estimation, pallet distance estimation, and/or robot velocity estimation, such as accelerometers, radar sensors, infrared sensors, laser sensors, and other sensors. The mobile robot may further include appropriate modules to process distance and velocity data received from such sensors.

Filter 818 uses the pallet velocity estimates, pallet distance estimates, and mobile robot velocity estimates to output state information of the robot and pallet that may be used to detect a load jam. Filter 818 may be a Kalman filter. Filter 818 uses an application programming interface to receive updates of the pallet velocity estimates, pallet distance estimates, and mobile robot velocity estimates from the various modules. Using a process covariance matrix, the filter 818 takes pallet velocity estimates, pallet distance estimates, and mobile robot velocity estimates, and outputs state estimates for the mobile robot and/or the pallet. For example, the filter 818 may output, as system state information, one or more of pallet velocity, pallet distance, and/or mobile robot velocity to the state monitor 820.

State monitor 820 uses the system state information to determine if a load jam occurs. For example, the state monitory may receive as system state information, one or more of pallet velocity, pallet distance, and/or mobile robot velocity. The state monitor 820 may determine if the mobile robot is within a threshold distance of the pallet. For example, in some embodiments, there may be a detector distance enable, where load jams are only detected when the pallet is within the robot's footprint (e.g., a threshold distance such as 1.3 m, 1.0 m, 0.5 m or another threshold). The state monitor 820 may also determine if the mobile robot is moving within a threshold loading velocity. For example, there may be a robot velocity threshold that sets a minimum speed for a load jam to be detectable (such as 2.0 cm/s, 1.0 cm/s, or 0.5 cm/s, compared to a typical docking speed of 25 cm/s). The state monitor 820 may then determine if the relative velocity of the pallet to the mobile robot is greater than a threshold amount.

The state monitor 820 may detect a load jam when the velocity of the pallet is greater than a threshold amount of the mobile robot velocity. For example, a relative velocity threshold may be used by the state monitor 820 to trigger a detection if the pallet is moving at a particular fraction of the robot's velocity (such as 45%, 55%, or 65%). Upon detecting a load jam, the state monitor 820 may provide an indication of the load jam to a navigation system of the mobile robot. For example, in response to determining that the velocity of the pallet surface is within a threshold value of the velocity of the mobile robot, the state monitor 820 may trigger an alarm condition, and based on the alarm condition, the navigation system may cease a pallet load operation that was in progress.

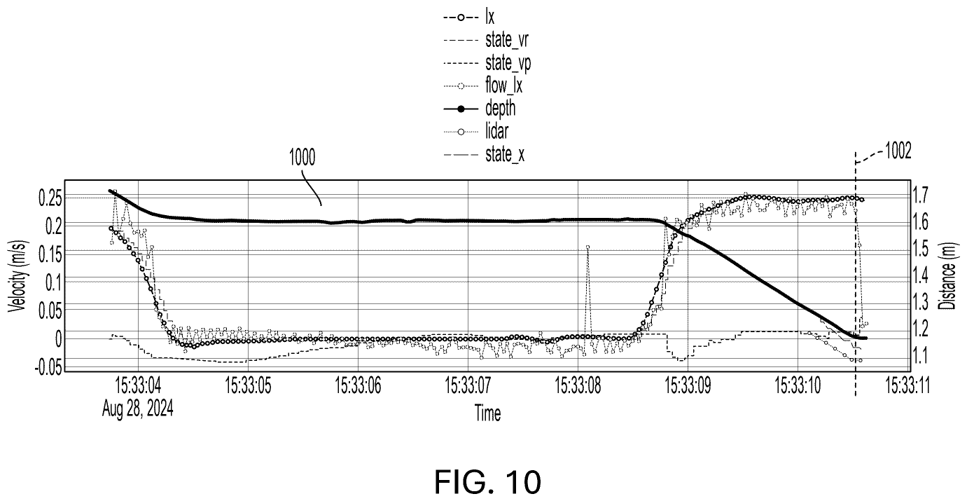

FIG. 10 is a plot 1000 of data for determining a load jam of a mobile robot, according to some embodiments. This plot 1000 shows incoming sensor measurements alongside the state of the Kalman filter. 1x indicates the robot velocity estimate from the odometry module, state_vr indicates the filtered state of robot velocity, state_vp indicates the filtered state of pallet velocity, flow_1x indicates the pallet velocity estimate from the optical flow module, depth indicates the pallet distance estimate from the depth module, lidar indicates the pallet distance estimate from the LiDAR module, and state_x indicates the filtered state of pallet distance. According to some embodiments, a load jam may be detected when one or more of the following occurs: the pallet velocity estimate from the optical flow module or the filtered state of pallet velocity changes rapidly (e.g., dropping or jumping), or the pallet distance estimate from the depth module, the pallet distance estimate from the LiDAR module, or the filtered state of pallet distance plateaus (e.g., goes from a changing state to a constant state). In FIG. 10, based on these conditions, a load jam may be detected at time 1002. Note that while plot 1000 shows lidar and depth offset, this may be due to a calibration issue of the particular data shown, and this is not necessarily typical of all data for load jam determination.

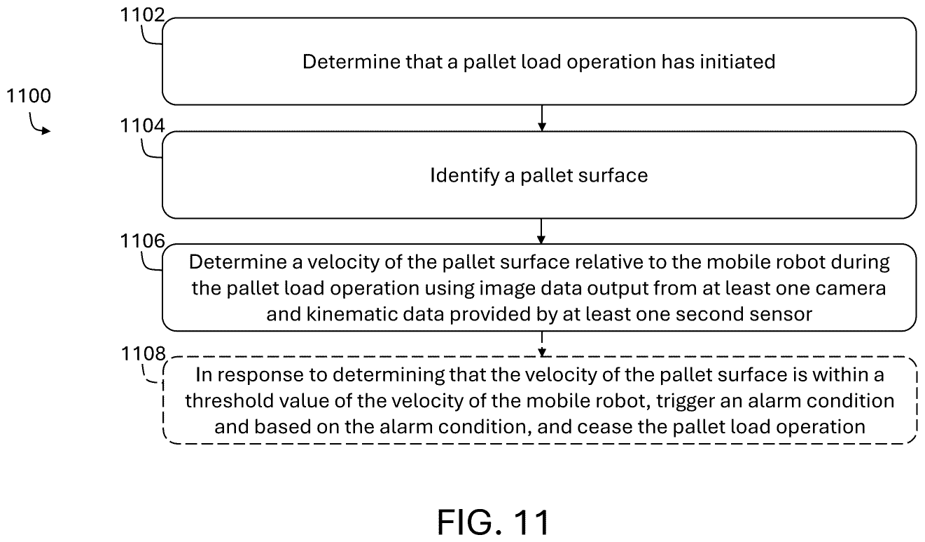

FIG. 11 shows a process flow 1100 for a method of detecting load jams during pallet load operations of a mobile robot. Process flow 1100 comprises step 1102, step 1104, step 1106, and may also include optional step 1108. At step 1102, the mobile robot determines that a pallet load operation has initiated. At step 1104, the mobile robot identifies a pallet surface. At step 1106, the mobile robot determines a velocity of the pallet surface relative to the mobile robot during the pallet load operation using image data output from at least one camera and kinematic data provided by at least one second sensor. Optionally, at step 1110, the mobile robot, in response to determining that the velocity of the pallet surface is within a threshold value of the velocity of the mobile robot, triggers an alarm condition and based on the alarm condition, and ceases the pallet load operation.

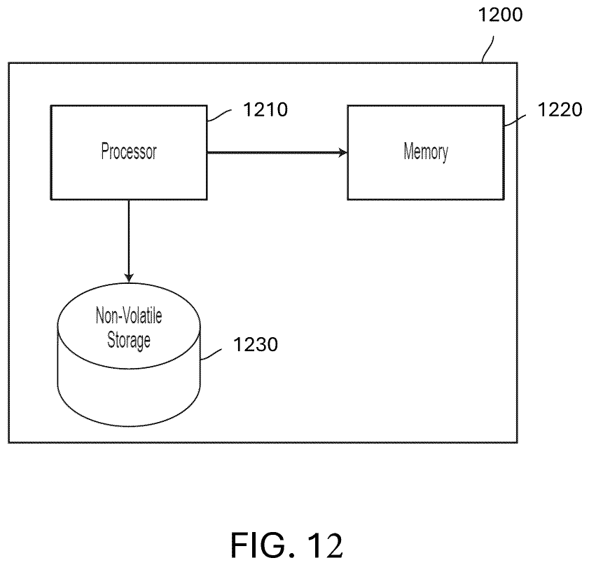

An illustrative implementation of a computer system 1200 that may be used in connection with any of the embodiments of the disclosure provided herein is shown in FIG. 12. The computer system 1200 may include one or more processors 1210 and one or more articles of manufacture that comprise non-transitory computer-readable storage media (e.g., memory 1220 and one or more non-volatile storage media 1230). The processor 1210 may control writing data to and reading data from the memory 1220 and the non-volatile storage device 1230 in any suitable manner. To perform any of the functionality described herein, the processor 1210 may execute one or more processor-executable instructions stored in one or more non-transitory computer-readable storage media (e.g., the memory 1220), which may serve as non-transitory computer-readable storage media storing processor-executable instructions for execution by the processor 1210.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be object of this disclosure. Accordingly, the foregoing description and drawings are by way of example only.

What is claimed is:

1. A mobile robot, comprising:
a set of wheels configured to move the mobile robot;
a pallet fork configured to lift and carry pallets;
a plurality of sensors comprising:
at least one camera configured to output image data; and
at least one second sensor configured to provide kinematic data; and
at least one processor configured to:
determine that a pallet load operation has initiated;
identify a pallet surface; and
determine a velocity of the pallet surface relative to the mobile robot during the pallet load operation using image data output from the at least one camera and kinematic data provided by the at least one second sensor.

2. The mobile robot of claim 1, wherein determining the velocity of the pallet surface relative to the mobile robot comprises determining whether a velocity of the pallet surface is within a threshold value of a velocity of the mobile robot.

3. The mobile robot of claim 2, wherein the at least one processor is further configured to:
in response to determining that the velocity of the pallet surface is within the threshold value of the velocity of the mobile robot, trigger an alarm condition; and
based on the alarm condition, cease the pallet load operation.

4. The mobile robot of claim 1, wherein:
determining the velocity of the pallet surface relative to the mobile robot comprises using an intensity camera to:
select at least one point on the pallet surface;
determine a position of the at least one point on the pallet surface in image data from at least two frames in time; and
determine the velocity of the pallet surface relative to the mobile robot based on a difference in the position of the at least one point on the pallet surface in the image data from the at least two frames in time.

5. The mobile robot of claim 1, wherein:
the at least one camera comprises a depth camera;
the at least one second sensor comprises an odometry encoder; and
determining the velocity of the pallet surface relative to the mobile robot comprises determining the velocity of the pallet surface relative to the mobile robot using the depth camera and the odometry encoder.

6. The mobile robot of claim 1, wherein:
the at least one camera comprises an intensity camera; and
identifying the pallet surface comprises identifying the pallet surface using the intensity camera.

7. The mobile robot of claim 1, wherein:
the plurality of sensors comprises a depth camera and an intensity camera; and
determining the velocity of the pallet surface relative to the mobile robot comprises fusing kinematic data provided by (i) the depth camera and (ii) the intensity camera.

8. The mobile robot of claim 1, wherein:
the at least one camera comprises a depth camera and an intensity camera;
the at least one second sensor comprises at least one of an ultrasonic sensor or a LiDAR sensor; and
determining the velocity of the pallet surface relative to the mobile robot comprises fusing kinematic data provided by (i) the depth camera, (ii) the intensity camera, and (iii) the at least one of the ultrasonic sensor or the LiDAR sensor.

9. A method of detecting load jams during pallet load operations of a mobile robot, the method comprising:
determining that a pallet load operation has initiated;
identifying a pallet surface; and
determining a velocity of the pallet surface relative to the mobile robot during the pallet load operation using image data output from at least one camera and kinematic data provided by at least one second sensor.

10. The method of claim 9, further comprising:
detecting a pallet;
positioning the mobile robot facing the pallet; and
performing the pallet load operation.

11. The method of claim 9, wherein:
determining the velocity of the pallet surface relative to the mobile robot comprises determining whether a velocity of the pallet surface is within a threshold value of a velocity of the mobile robot.

12. The method of claim 11, further comprising:
in response to determining that the velocity of the pallet surface is within the threshold value of the velocity of the mobile robot, triggering an alarm condition; and
based on the alarm condition, ceasing the pallet load operation.

13. The method of claim 9, wherein:
determining the velocity of the pallet surface relative to the mobile robot comprises using an intensity camera to:
select at least one point on the pallet surface;
determine a position of the at least one point on the pallet surface in image data from at least two frames in time; and
determine the velocity of the pallet surface relative to the mobile robot based on a difference in the position of the at least one point on the pallet surface in the image data from the at least two frames in time.

14. The method of claim 9, wherein:
determining the velocity of the pallet surface relative to the mobile robot comprises determining the velocity of the pallet surface relative to the mobile robot using a depth camera and an odometry encoder.

15. The method of claim 9, wherein:
identifying the pallet surface comprises identifying the pallet surface using an intensity camera.

16. The method of claim 9, wherein:
determining the velocity of the pallet surface relative to the mobile robot comprises fusing kinematic data provided by (i) a depth camera and (ii) an intensity camera.

17. The method of claim 9, wherein:
determining the velocity of the pallet surface relative to the mobile robot comprises fusing kinematic data provided by (i) a depth camera, (ii) an intensity camera, and (iii) at least one of an ultrasonic sensor or a LiDAR sensor.

18. At least one non-transitory computer-readable storage medium having instructions encoded thereon that, when executed by at least one processor, cause the at least one processor to perform a method of detecting load jams during pallet load operations of a mobile robot, the method comprising:
determining that a pallet load operation has initiated;
identifying a pallet surface; and
determining a velocity of the pallet surface relative to the mobile robot during the pallet load operation using image data output from at least one camera and kinematic date provided by at least one second sensor.

19. The at least one non-transitory computer-readable storage medium of claim 18, wherein:
identifying the pallet surface comprises identifying the pallet surface using an intensity camera; and
determining the velocity of the pallet surface relative to the mobile robot comprises:
using the intensity camera to:
select at least one point on the pallet surface;
determine a position of the at least one point on the pallet surface in image data from at least two frames in time; and
determine velocity data based on a difference in the position of the at least one point on the pallet surface in the image data from the at least two frames in time; and
determining the velocity of the pallet surface relative to the mobile robot by fusing the velocity data and depth data from the at least one second sensor.

20. The at least one non-transitory computer-readable storage medium of claim 19, wherein:
fusing the velocity data and depth data from the at least one second sensor comprises:
inputting, into a model, the velocity data and the depth data from the at least one second sensor; and
determining, based on an output from the model, the velocity of the pallet surface relative to the mobile robot.

21. The at least one non-transitory computer-readable storage medium of claim 19, wherein:
determining the position of the at least one point on the pallet surface in the image data from the at least two frames in time comprises:
inputting, into a model, image data from the at least two frames in time; and
determining, based on an output from the model, the position of the at least one point on the pallet surface in the image data from the at least two frames in time.

22. The at least one non-transitory computer-readable storage medium of claim 18, wherein:
determining the velocity of the pallet surface relative to the mobile robot comprises fusing kinematic data provided by (i) a depth camera and (ii) an intensity camera.
